(19) United States
(12) Patent Application Publication
(10) Pub. No.: US 2011/0215533 A1
(43) Pub. Date: Sep. 8, 2011

(54) RECIPROCATING SHAFT'S SEALING APPARATUS COMBINED A FERROFLUID SEAL WITH A C-SLIP-RING AND A YX-SEAL-RING

(75) Inventors: Decai Li, Beijing (CN); Jishang Wang, Beijing (CN)

(73) Assignee: Beijing Jiaotong University

(21) Appl. No.: 13/040,328

(22) Filed: Mar. 4, 2011

(30) Foreign Application Priority Data
Mar. 8, 2010 (CN) 201010120449.3

(51) Int. Cl. F16J 15/43

(52) U.S. Cl. 277/410

(57) ABSTRACT

A reciprocating shaft's sealing apparatus combined a ferrofluid seal with a C-slip-ring and a Yx-seal-ring, characterized in that the first O-ring (3), the first Yx-seal-ring (4) and the first C-slip-ring (5) are installed into the grooves of the first fixed base (2), respectively, the second O-ring (15), the second Yx-seal-ring (14) and the first C-slip-ring (13) are installed into the grooves of the second fixed base (16), respectively, the first fixed base, the first pole piece (7) installed with an O-ring, a magnet (10), the second pole piece (11) installed with an O-ring and the second fixed base are placed in series at the bottom of the charmer of the sealing base (1), the above parts are pressed tightly by the end cover by means of the bolts connected with the sealing base, and the ferrofluid is injected into the magnet before assembling. The apparatus solves the problem of leakage in the reciprocating type of compressors.

### FIELD OF THE PRESENT INVENTION

The invention is related to the sealing technology in mechanical engineering, especially to the seal of reciprocating shafts in vacuum coating machines and compressors where the working temperature is below 150° C. and the sealing medium is gas.

### BACKGROUND OF THE PRESENT INVENTION

The compressors are universal machines used to compress gas to increase the pressure of the gas and transport gas. There are three types of compressors in widely use: the reciprocating type, the screw type, and the centrifugal type, in which the reciprocating type of compressors are widely used in mining, metallurgy, petroleum and chemical industry because of its high efficiency and high pressure. But there is a problem of a leakage in the reciprocating type of compressors, and this problem is severe because of its wide use, especially in the compressing and transporting the inflammable, explosive and noxious gas. There are two types of sealing for the piston rod of the reciprocating compressors in prior art, i.e. a packing seal and a labyrinth seal. The packing seal is a type of contacting seal. It is easy to suffer abrasion in high pressure, which will result in a short life of the packing seal. And there is mass of leakage in lower pressure because the back pressure is not sufficient. Piston compressors with the labyrinth seal require high precision of the manufacture, and only a few firms can produce this type of seal. The ferrofluid seal utilizes the response to magnetic field, forming the fluid “O” rings of ferrofluid one by one on the surface of the shaft after the ferrofluid is injected into the gap between the pole pieces and the shafts. The ferrofluid seal has not very high requirement for the surface precision, and the shaft and pole piece do not contact with each other. So there is little heat generation. But the ferrofluid in the sealing gaps will distort when the shaft moves and the ferrofluid under each teeth will be carried to the teeth at the front end in the moving direction. Such that when the excess ferrofluid cannot be restrained by the magnetic field under the teeth in front end, an amount of ferrofluid will loss, which will result in the reduction of the sealing life and the pressure capability or pressure endurance capability, and in the increase of the leakage of the sealed medium. So it is difficult to solve the problem of the reciprocating type of compressors using only one of the sealing structures discussed above.

### SUMMARY OF THE PRESENT INVENTION

The object of the present invention is to provide a reciprocating shaft's sealing apparatus combined a ferrofluid seal with a C-slip-ring and a Yx-seal-ring, which can solve the problem of the leakage of piston rod in compressors which any single sealing method cannot solve.

The technical solutions of the present invention are as follows.

A reciprocating shaft's sealing apparatus combined a ferrofluid seal with a C-slip-ring and a Yx-seal-ring, characterized in that the first O-shaped rubber seal ring is installed into the annular groove on the outer surface of the first fixed base; the first Yx-seal-ring is inserted into the annular groove at the left side of the inner surface of the first fixed base; the first C-slip-ring is inserted into the annular groove at the right side of the inner surface of the first fixed base;

the second O-shaped rubber seal ring is installed into the annular groove on the outer surface of the second fixed base; the second Yx-seal-ring is inserted into the annular groove at the right side of the inner surface of the second fixed base; the second C-slip-ring is inserted into the annular groove at the left side of the inner surface of the second fixed base;

the first fixed base, the first pole piece installed with O-shaped rubber seal rings, a magnet, the second pole piece installed with O-shaped seal rings, and the second fixed base are placed in series on the bottom of chamber of the sealing base installed with O-shaped rubber seal ring, in which the center line of the hole provided in the magnet is arranged to coincide with that of the middle thread hole at the sealing base;

the end cover is connected with the sealing base by means of bolts, such that the end cover is adapted to press the above listed parts; the fixed plug is inserted into the hole of the magnet via the threaded hole of the sealing base; the fixed plug is contacted with the outer surface of the magnet by tightening the bolt;

the first water intake and the second water intake are connected with the outlet of the cooling water; the first water outlet and the second water outlet are connected with the intake of the cooling water; and

the ferrofluid is injected into the inner torus of the magnet before the reciprocating shaft's sealing apparatus is assembled onto the shaft.

The beneficial effect of this invention is that the reciprocating shaft's sealing apparatus combined a ferrofluid seal with a C-slip-ring and a Yx-seal-ring can solve the problem of leakage on piston rod of the reciprocating type of compressors. The C-slip-ring and the Yx-seal-ring in this apparatus can prevent the ferrofluid from going away together with the reciprocating shaft and prevent the ferrofluid from transforming during the reciprocating of the shaft. This apparatus has a long sealing life and the temperature of is the shaft can keep very low.

### DESCRIPTION OF THE ACCOMPANYING DRAWINGS

FIG. 1 shows the structure of a reciprocating shaft's sealing apparatus combined a ferrofluid seal with a C-slip-ring and a Yx-seal-ring.

FIG. 2 shows the profile of the first and the second pole piece.

FIG. 3 is the enlarged view of part A as shown in FIG. 2.

FIG. 4 shows the profile of the first and the second fixed base.

FIG. 5 shows the profile of the end cover.

FIG. 6 shows the profile of the sealing base.

In the figures, there are shown a sealing base 1, the first fixed base 2, the first O-ring 3, the first Yx-seal-ring 4, the first C-slip-ring 5, the first water intake 6, the first pole piece 7 installed with an O-ring, bolt 8, a fixed plug 9, a magnet 10, the second pole piece 11 installed with an O-ring, the second C-slip-ring 12, the second water intake 13, the second Yx-seal-ring 14, the second O-ring 15, the second fixed base 16, an end cover 17, bolts 18, the first water outlet 19, and the second water outlet 20.

### Preferred Embodiments to Carry out the Present Invention

A further explanation of embodiments of this invention is made with the attached drawings.

A reciprocating shaft's sealing apparatus combined a ferrofluid seal with a C-slip-ring and a Yx-seal-ring is provided. The first O-ring 3 is installed into the annular groove on the outer surface of the first fixed base 2. The first Yx-seal-ring 4 is inserted into the annular groove at the left side of the inner surface of the first fixed base 2. The first C-slip-ring is inserted into the annular groove at the right side of the inner surface of the first fixed base 2.

The second O-ring 15 is installed into the annular groove on the out surface of the second fixed base 16. The second Yx-seal-ring 14 is inserted into the annular groove at the right side of the inner surface of the second fixed base 16. The second C-slip-ring is inserted into the annular groove at the left side of the inner surface of the second fixed base 16.

The above first fixed base 2, the first pole piece 7 installed with an O-ring, a magnet 10, the second pole piece 11 installed with an O-ring, and the second fixed base 16 are placed on the bottom of chamber of the sealing base 1 installed with an O-ring. It must make sure that the center line of the hole of the magnet 10 coincide with that of the middle thread hole of the sealing base 1.

The end cover 17 is connected with the sealing base 1 by means of bolts 18. Such that the end cover 17 presses the above parts. The fixed plug 9 is inserted into the hole of the magnet 10 from the hole at the sealing base 1. The fixed plug 9 is contacted with the outer surface of the magnet 10 by tightening the bolt 8. The ferrofluid can be injected into the magnet 10 after the fixed plug is taken down, when some based fluid in ferrofluid is evaporated because the shaft surface temperature is increased.

The first and the second water intakes 6 and 13 are connected with the outlet of the cooling water. The first and the second water outlets 19, 20 are connected with the intake of the cooling water. When the sealing apparatus is working, the cycle of the cooling water is ensured by the water inlet and outlet intakes, such that the heat dissipation can be improved and the evaporation of the ferrofluid can be reduced.

The ferrofluid is injected into the inner torus of the magnet 10 before the reciprocating shaft's sealing apparatus combined a ferrofluid seal with a C-slip-ring and a Yx-seal-ring is assembled onto the shaft. During working, whenever the ferrofluid needs to be added, the fixed plug can be taken down, then the ferrofluid can be injected into the hole provided on the magnet 10.

The sealing base 1 with an O-shaped rubber seal ring is provided with the first water intake 6, the second water intake 13, the first water outlet 19, the second water outlet 20, and the middle thread hole. The distance between the center line of the first water inlet 6 and side surface of the chamber of the sealing base 1 is l₁+(l₂−l₁)/2, where l₁ is the axial thickness of the boss provided at the left side of the first fixed base 2, l₂ is the total axial length of the first fixed base 2, l₃ is the distance between the edge of the counterbore and the outer cylinder surface of the first pole piece 7, l₄ is the thickness of the magnet. The distance between the center line of the thread hole placing the plug screw 8 and that of the first water intake is l₃+(l₂−l₁+l₄)/2. The distance between the center line of the thread hole placing the plug screw 8 and that of the second water intake is l₃+(l₂−l₁+l₄)/2.

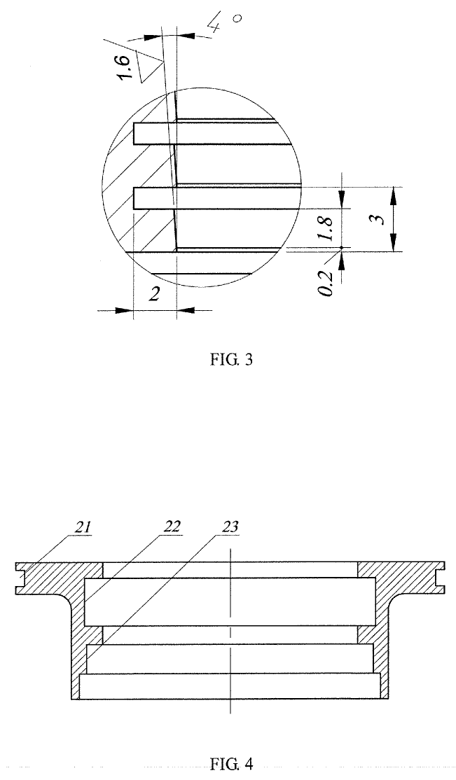

The first pole piece 7 installed with an O-shaped rubber seal ring and second pole piece 11 installed with an O-shaped rubber seal ring are with such parameters of the teeth that the facewidth of the tooth is 2 mm, the width of the tooth space is 1 mm, the depth of the tooth space is 2 mm, the angle between the tooth outmost generatrix and the tilt portion of the tooth tip is 4°. The axial length of the torus at the top of the teeth is 0.2 mm. The axial length of the tilt portion at the top of the teeth is 1.8 mm, as shown in FIG. 3.

The ferrofluid used here is kerosene based ferrofluid, and the diameter of the magnetic particles is smaller than 5 nm.

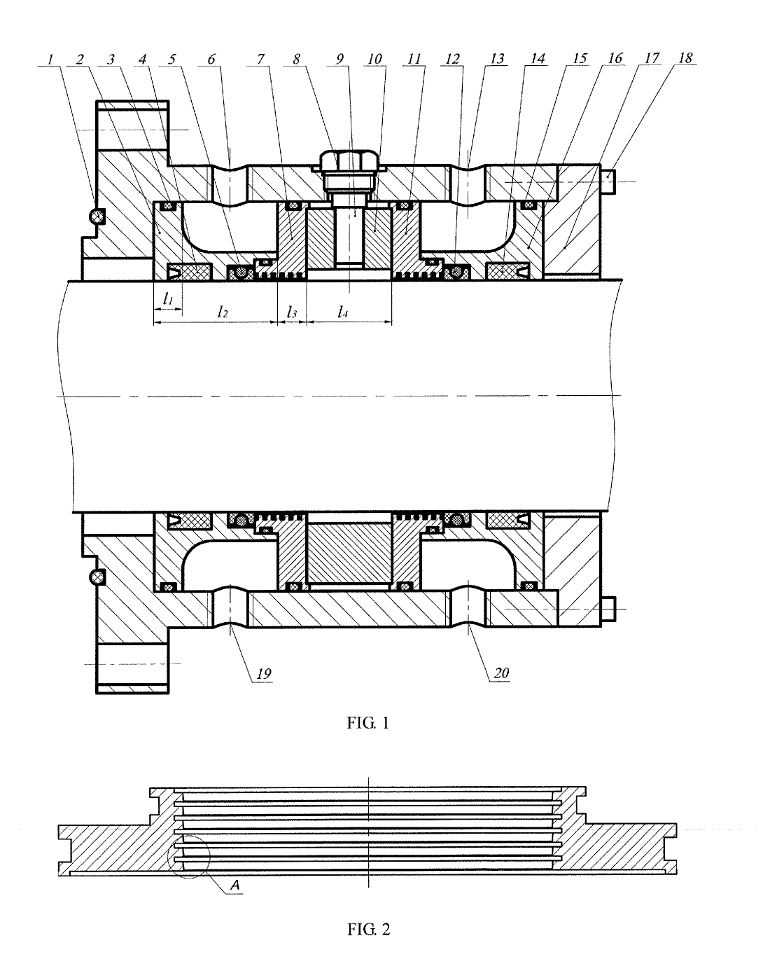

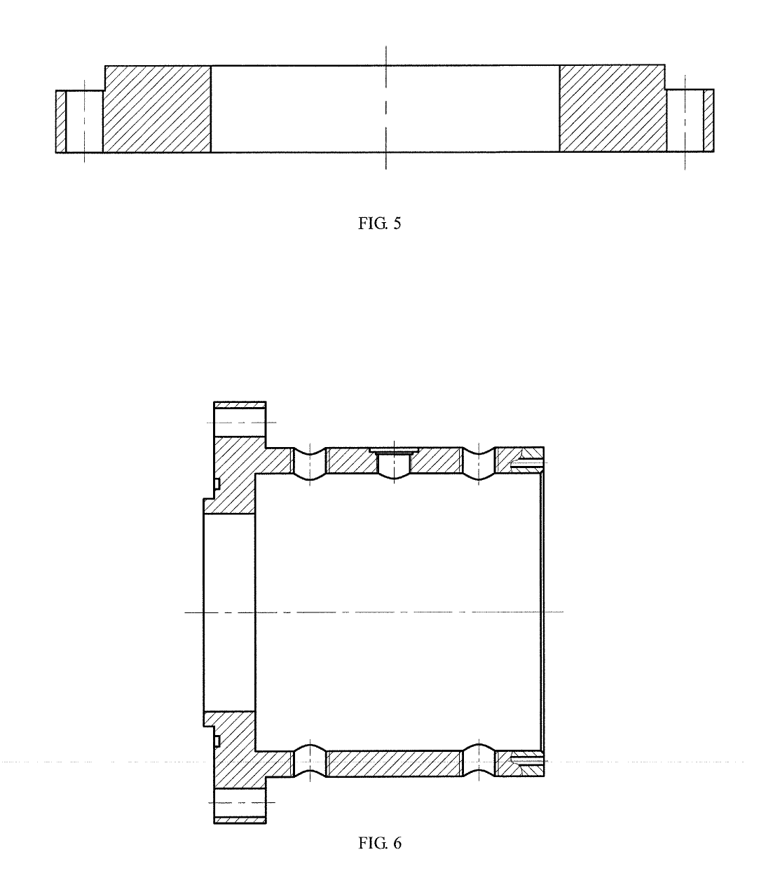

The sealing base 1 with an O-shaped rubber seal ring is shown in FIGS. 1 and 6. A sealing groove is designed at the left side surface of the flange of the sealing base 1, and an O-ring is placed into the sealing groove. There are four holes and six thread holes at the flange and the right end of the sealing base 1, respectively. The four holes are used to connect with the sealed charmer, and the six thread holes are used to connect with the end cover 16.

The first fixed base 2 has the same structure as the second fixed base 16.

The first pole piece has the same structure and the same dimension as the second pole piece. There are two sealing grooves at their outer surfaces, which are used to receive O-rings, as shown in FIG. 2. The teeth are provided on the surface of the smaller inner holes.

The first fixed base has the same structure and the same dimension as the second fixed base. The O-ring is placed into the groove 21 at the outer surface. The Yx-seal-ring is placed into the first groove 22 at the inner surface. The C-slip-ring is placed into the second groove 23 at the inner surface, as shown in FIG. 4, so as to avoid the loss of ferrofluid during the reciprocating motion of the shaft.

There are six holes at the end surface of the end cover 17, which are used to connect with the sealing base with the O-shaped rubber seal ring, as shown in FIG. 5.

The sealing grooves are designed at the left side surface of the flange of the sealing 1, in which O-shaped rubber seal rings are placed.

All the O-rings are made of fluororubber. The material of the magnet is Nd—Fe—B. The material of the first and the second pole pieces is DT3. The material of the fixed plug is polytetrafluoroethylene. The material of the Yx-seal-rings is polyurethane.

This apparatus was used to seal a reciprocating shaft with diameter of 80 mm. There were 6 teeth on each pole pieces. The sealing gap was 0.2 mm, the width of the teeth was 2 mm, the width of the tooth groove is 1 mm, the depth of the tooth groove is 2 mm. The material of the permanent magnet was Nd—Fe—B. The material of the Yx-seal-rings was polyurethane. Ferrofluid based on kerosene was used. Effective seal was obtained when the stroke was 280 mm and the rotating speed of crank is 192 r/m.

1. A reciprocating shaft's sealing apparatus combined a ferrofluid seal with a C-slip-ring and a Yx-seal-ring, characterized in that the first O-shaped rubber seal ring (3) is installed into the annular groove on the outer surface of the first fixed base (2); the first Yx-seal-ring (4) is inserted into the annular groove at the left side of the inner surface of the first fixed base (2); the first C-slip-ring (5) is inserted into the annular groove at the right side of the inner surface of the first fixed base (2);
the second O-shaped rubber seal ring (15) is installed into the annular groove on the outer surface of the second fixed base (16); the second Yx-seal-ring (14) is inserted into the annular groove at the right side of the inner surface of the second fixed base (16); the second C-slip-ring (12) is inserted into the annular groove at the left side of the inner surface of the second fixed base (16);
the first fixed base (2), the first pole piece (7) installed with O-shaped rubber seal rings, a magnet (10), the second pole piece (11) installed with O-shaped seal rings, and the second fixed base (16) are placed in series on the bottom of chamber of the sealing base (1) installed with O-shaped rubber seal ring, in which the center line of the hole provided in the magnet (10) is arranged to coincide with that of the middle thread hole at the sealing base (1);
the end cover (17) is connected with the sealing base (1) by means of bolts (18), such that the end cover (17) is adapted to press the above listed parts; the fixed plug (9) is inserted into the hole of the magnet (10) via the threaded hole of the sealing base (1); the fixed plug (9) is contacted with the outer surface of the magnet (10) by tightening the bolt (8);
the first water intake (6) and the second water intake (13) are connected with the outlet of the cooling water; the first water outlet (19) and the second water outlet (20) are connected with the intake of the cooling water; and
the ferrofluid is injected into the inner torus of the magnet (10) before the reciprocating shaft's sealing apparatus is assembled onto the shaft.

2. A reciprocating shaft's sealing apparatus combined a ferrofluid seal with a C-slip-ring and a Yx-seal-ring according to claim 1, characterized in that the first water intake (6), the second water intake (13), the first water outlet (19), the second water outlet (20), and the middle thread hole are provided on the sealing base (1); the distance between the center line of the first water intake (6) and side surface of the chamber of the sealing base (1) is l₁+(l₂−l₁)/2, where l₁ is the axial thickness of the boss provided at the left side of the first fixed base (2), l₂ is the total axial length of the first fixed base (2), l₃ is the distance between the edge of the counterbore and the outer cylinder surface of the first pole piece (7), l₄ is the thickness of the magnet; the distance between the center line of the thread hole receiving the plug screw (8) and that of the first water intake is l₃+(l₂−l₁+l₄)/2; the distance between the center line of the thread hole receiving the plug screw (8) and that of the second water intake is l₃+(l₂−l₁+l₄)/2.

3. A reciprocating shaft's sealing apparatus combined a ferrofluid seal with a C-slip-ring and a Yx-seal-ring according to claim 1, characterized in that among the parameters of the teeth provided on the first pole piece (7) and the second pole piece (11), the facewidth of the tooth is 2 mm, the width of the tooth space is 1 mm, the depth of the tooth space is 2 mm, the angle between the tooth outmost generatrix and the tilt portion of the tooth tip is 4°, the axial length of the torus at the top of the teeth is 0.2 mm, and the axial length of the tilt portion at the top of the teeth is 1.8 mm.

4. A reciprocating shaft's sealing apparatus combined a ferrofluid seal with a C-slip-ring and a Yx-seal-ring according to claim 1, characterized in that the ferrofluid used here is kerosene based ferrofluid, and the diameter of the magnetic particles is smaller than 5 nm.
